(19) United States
(12) Patent Application Publication
(10) Pub. No.: US 2024/0338195 A1
(43) Pub. Date: Oct. 10, 2024

(54) EFFICIENT FIRMWARE PATCHING USING ACCRETIVE PATCHES

(71) Applicant: Cirrus Logic International Semiconductor Ltd., Edinburgh (GB)

(72) Inventors: Mark P. GROTEWALD, Austin, TX (US); Roshan KAMATH, Austin, TX (US); Nariankadu D. HEMKUMAR, Austin, TX (US); Franz J. WELLER, Austin, TX (US)

(73) Assignee: Cirrus Logic International Semiconductor Ltd., Edinburgh (GB)

(21) Appl. No.: 18/295,762

(22) Filed: Apr. 4, 2023

(51) Int. Cl. G06F 8/65

(52) U.S. Cl. CPC G06F 8/65

(57) ABSTRACT

A method for generating a software patch with a desired feature set comprising one or more features may include determining existing features of an existing set of existing software including any features associated with previous software patches to the existing software and creating the software patch as an accretive patch that includes only features of the desired feature set absent from the existing features, such that when the software patch is applied, the existing software together with the software patch provides the desired feature set.

### FIELD OF DISCLOSURE

The instant disclosure relates generally to processing systems, and more specifically, to systems and methods for using accretive patches to firmware to enable patching which efficiently uses read-only memory.

### BACKGROUND

Processing systems are ubiquitous in both computing systems and embedded applications in consumer and industrial devices. Update of so-called read-only program code historically involved replacement of a read-only memory (ROM) device within the computer or other device containing the ROM code. Generally such devices are not field replaceable, and return to a service center or factory is required. One-time programmable (OTP) memory is a type of ROM that is often used in electronic devices to store executable code or data. An advantage of OTP memory is that it allows ROM code to be added to a device after manufacture. However, one drawback of OTP memories and other ROMs is that they may be written once, but not erased.

As an alternative, electrically alterable read-only memories have been developed and techniques associated with those technologies implemented in software that permits a field modification to ROM devices, thus alleviating the need for factory service to upgrade the ROM program code.

However, several drawbacks are present with the use of electrically alterable memories, including a limited number of write cycles to failure and limited fail-safe storage lifetimes. Most significantly, larger die areas and higher power requirements compared to OTP memories and ROMs, and the need to program the memories in conjunction with integration, make the use of OTP memories and/or other ROMs preferable to electrically-alterable ROM. Also, the technology requirements for electrically alterable ROM technologies are incompatible with some fabrication technologies or otherwise complicates the fabrication process, thus raising the cost when the electrically alterable ROM is included on a die with other circuits.

As indicated above, OTP memories are storage which may be written once, but not erased. Thus, each software modification or patch written to an OTP memory irrevocably consumes a portion of a device's storage. In an environment where software storage is limited or permanent, and where once-written software cannot be erased, it is critical to use space as efficiently as possible to extend lifetime of a device. Applying a software patch to an OTP memory or other ROM storage that invalidates or completely supersedes previous patches wastes limited storage space and reduces overall lifetime of a device by unduly limiting the number of times a device's software may be patched.

### SUMMARY

In accordance with the teachings of the present disclosure, certain disadvantages and problems associated with updating software on an OTP memory may be reduced or eliminated.

In accordance with embodiments of the present disclosure, a method for generating a software patch with a desired feature set comprising one or more features may include determining existing features of an existing set of existing software including any features associated with previous software patches to the existing software and creating the software patch as an accretive patch that includes only features of the desired feature set absent from the existing features, such that when the software patch is applied, the existing software together with the software patch provides the desired feature set.

In accordance with these and other embodiments of the present disclosure, a system for generating a software patch with a desired feature set comprising one or more features may include a processor configured to determine existing features of an existing set of existing software including any features associated with previous software patches to the existing software and create the software patch as an accretive patch that includes only features of the desired feature set absent from the existing features, such that when the software patch is applied, the existing software together with the software patch provides the desired feature set.

In accordance with embodiments of the present disclosure, a method for using a software patch with a desired feature set comprising one or more features may include applying a software patch comprising an accretive patch that includes only features of a desired feature set absent from existing features of existing software including any features associated with previous software patches to the existing software, such that when the software patch is applied, the existing software together with the software patch provides the desired feature set.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example processing system, in accordance with embodiments of the present disclosure;

FIG. 2 illustrates an example chronology for firmware lineages for two different electronic devices, in accordance with embodiments of the present disclosure; and

FIG. 3 illustrates a table that sets forth each of the patches shown in FIG. 2, along with a feature set and jump table changes associated with each patch, in accordance with embodiments of the present disclosure.

### DETAILED DESCRIPTION

In accordance with embodiments of this disclosure, systems and methods disclosed herein may apply a series of dependent software patches to efficiently modify software in an environment with limited or permanent storage. These systems and methods may consider existing patches present on a device as its lineage and create a child patch in an accretive manner that utilizes prior patches as much as possible to minimize size of the child patch. Such an approach may provide multiple paths to the same end functionality. Each patch may be developed to reuse existing patch functionality and only extend functionality as required to deliver a desired feature set.

A difference in lineage may exist among devices because devices are often programmed with the current software state when they are manufactured. Over time, many devices may be manufactured with different starting software states and intermediate software updates.

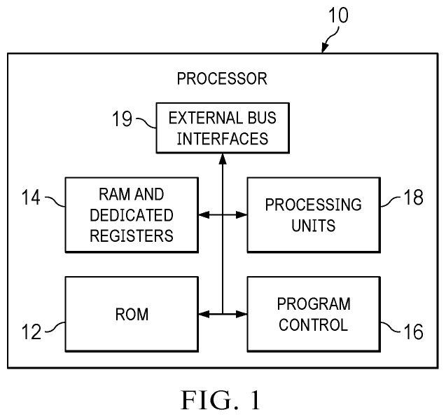

FIG. 1 illustrates a block diagram of selected components of an example processing system comprising processor 10, in accordance with embodiments of the present disclosure. Processor 10 may be of the form of a microprocessor or microcontroller suitable for use in embedded applications, such as digital signal processing cores included in larger “system on a chip” type integrated circuits that include other input/output and signal processing functions. In particular, processor 10 may include a ROM 12 and a random access memory (RAM)/register bank 14 coupled via an internal bus to processing units 18, a program control circuit 16, and external bus interfaces 19. Processor 10 is an exemplary device that embodies one or more of the techniques of the present disclosure. However, the techniques of the present disclosure may be used in any application with any type of processor that includes one or more of the improvements described herein.

Program control circuit 16 directs the execution of program instructions that cause processing units 18 to perform various tasks, such as floating-point and fixed-point operations, the loading of values to and from external bus interfaces 19, the loading and storing of program instructions and data to and from RAM 14, and the loading of program instructions from ROM 12. In particular, program control circuit 16 is responsible for the implementation of branching and looping instructions that are loaded from RAM 14 and ROM 12 when encountered in the sequence of execution of program code that is generally sequential in memory until a branch or looping instruction is encountered in the program instruction sequence.

In some embodiments, ROM 12 or portions thereof may be OTP memory. In such embodiments, ROM 12 or such portions thereof may store firmware.

In some embodiments, RAM 14 may include a jump table for execution of portions of ROM 12. As is known in the art, a jump table or branch table is a technique of transferring program control to another part of a program or to a different program using a table or branch or jump instructions.

A processor 10 as shown in FIG. 1 may comprise a device upon which firmware and patches/updates to firmware may be stored. A processor 10 as shown in FIG. 1 may also be used to create firmware images and firmware updates/patches that may be distributed to other devices.

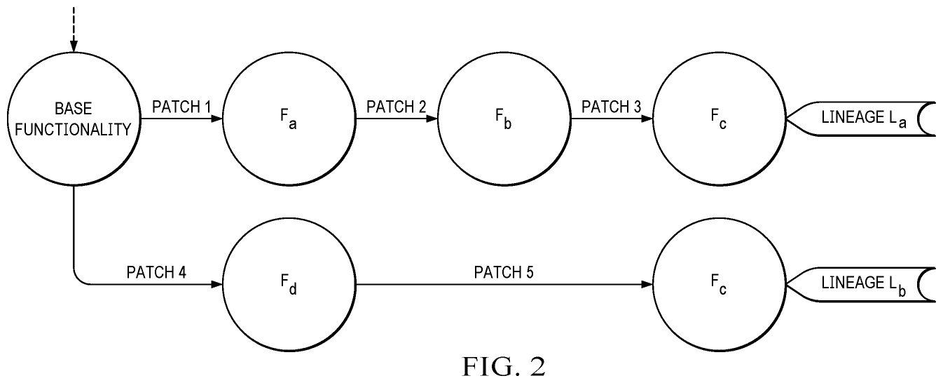

FIG. 2 illustrates an example chronology for firmware lineages Lₐ and L_{b} for two different electronic devices, in accordance with embodiments of the present disclosure. Each of such electronic devices may include a processor 10 as shown in FIG. 1. As shown in FIG. 2, a first device with lineage Lₐ may begin with base functionality, and may be patched at a given instance in time with a first patch (“Patch 1”) to arrive at a feature set Fₐ for the first device. At a later time, the first device may be patched with a second patch (“Patch 2”) to arrive at a feature set F_{b} for the first device, wherein the second patch may be an accretive patch to the first patch that utilizes as much of feature set Fₐ as possible to provide feature set F_{b} via the second patch. Thus, creation of the second patch may be dependent upon contents of the first patch. At an even later time, the first device may be patched with a third patch (“Patch 3”) to arrive at a feature set Fc, wherein the third patch may be an accretive patch to the first patch and the second patch that utilizes as much of feature set F_{b} as possible to provide feature set F_{c} via the third patch. Thus, creation of the third patch may be dependent upon contents of the first patch and the second patch.

As also shown in FIG. 2, a second device with lineage L_{b} may begin with base functionality, and may be patched at a given instance in time with a fourth patch (“Patch 4”) to arrive at a feature set F_{d} for the first device. At a later time, the second device may be patched with a fifth patch (“Patch 5”) to arrive at a feature set F_{c} for the second device, wherein the fifth patch may be an accretive patch to the fourth patch that utilizes as much of feature set F_{d} as possible to provide feature set F_{c} via the fifth patch. Thus, creation of the fifth patch may be dependent upon contents of the fourth patch.

The various patches may be stored in OTP memory (or other ROM 12) and/or RAM 14 of their respective target devices. RAMs are re-writable, which means they do not have the issue of irrevocable consumption like OTPs. However, accretive patching as described herein could also be used with RAM 14 in addition to OTP memory. Such accretive patching may allow the continued use of an existing patch for RAM, while extending or modifying the functionality of that patch by adding an accretive patch. Thus, an advantage of an accretive patch in RAM 14 is that a patch with a substantially large number of features may be made in a limited RAM environment.

In the example embodiment of FIG. 2, a feature set F_{c} that occurs in lineage Lₐ of the first device and lineage L_{b} of the second device refers to the same end functionality for both devices, but with such same end functionality arrived by different patch sequences, wherein each patch sequence relies on as much functionality as possible from previous patches. In other words, both devices end up with the same feature set F_{c}, but take different intermediate upgrade paths to arrive at such functionality.

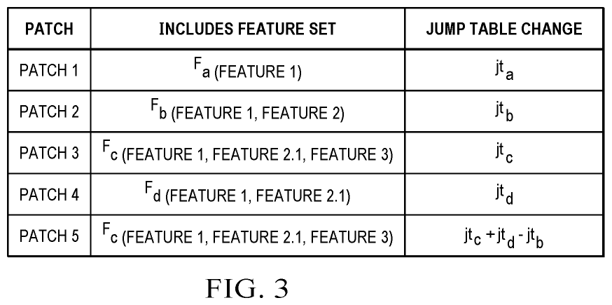

FIG. 3 illustrates a table that sets forth each of the patches shown in FIG. 2, along with a feature set and jump table changes associated with each patch, in accordance with embodiments of the present disclosure. As shown in FIG. 3, each patch may include a feature set Fₓ with a list of features that may be applied by a jump table modification jtₓ to a jump table in RAM 14 associated with the device to which the patch is applied. For example, in the first device, the first patch may include feature set Fₐ that adds a Feature 1 via a jump table addition jtₐ, the second patch may include feature set F_{b} that adds a Feature 2 via a jump table addition jt_{b}, and the third patch may include feature set F_{c} that adds Features 2.1 and 3 via a jump table addition jt_{c}. As another example, in the second device, the fourth patch may include feature set F_{d} that adds Feature 1 and 2.1 via a jump table addition jt_{d}, and the fifth patch may include feature set F_{c} that adds a Feature 3 via jump table additions jt_{c} and jt_{d}, and jump table deletion of jt_{b}.

Accordingly, using the systems and methods disclosed herein, a patch lineage for an electronic device may be dependent upon a history of patches previously applied to the electronic device in order to optimize usage of OTP memory storage space. Each patch may reference existing code in a device's lineage in order to minimize the size of the patch necessary to implement a feature set, effectively maximizing the lifespan of a write-constrained device.

The operations described above as performed by a processor may be performed by any circuit configured to perform the described operations. Such a circuit may be an IC constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuitry may be configured as a general-purpose processor (e.g., CPU or DSP) capable of executing instructions contained in software. The firmware and/or software may include instructions that cause the processing of signals described herein to be performed. The circuitry or software may be organized as blocks that are configured to perform specific functions. Alternatively, some circuitry or software may be organized as shared blocks that may perform several of the described operations. In some embodiments, the IC that is the controller may include other functionality. For example, the controller IC may include an audio coder/decoder (CODEC) along with circuitry for performing the functions described herein. Such an IC is one example of an audio controller. Other audio functionality may be additionally or alternatively integrated with the IC circuitry described herein to form an audio controller.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that may be accessed by a computer. By way of example, and not limitation, such computer-readable media may comprise random access memory (RAM), OTP memory, read-only memory (ROM), electrically-erasable programmable read-only memory (EEPROM), compact disc read-only memory (CD-ROM) or other optical disk storage, magnetic disk storage or other magnetic storage devices, or any other medium that may be used to store desired program code in the form of instructions or data structures and that may be accessed by a computer. Disk and disc includes compact discs (CD), laser discs, optical discs, digital versatile discs (DVD), floppy disks, and Blu-ray discs. Generally, disks reproduce data magnetically, and discs reproduce data optically. Combinations of the above should also be included within the scope of computer-readable media.

In addition to storage on computer readable media, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, where general purpose processors are described as implementing certain processing steps, the general purpose processor may be a digital signal processor (DSP), a graphics processing unit (GPU), a central processing unit (CPU), or other configurable logic circuitry. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A method for generating a software patch with a desired feature set comprising one or more features, the method comprising:
determining existing features of an existing set of existing software including any features associated with previous software patches to the existing software; and
creating the software patch as an accretive patch that includes only features of the desired feature set absent from the existing features, such that when the software patch is applied, the existing software together with the software patch provides the desired feature set.

2. The method of claim 1, wherein the software patch is configured to be stored in one-time programmable memory or random access memory of a target device for the software patch.

3. The method of claim 1, further comprising creating the software patch such that executable code of the software patch updates a jump table stored in random access memory of the target device to reference the desired feature set.

4. A system for generating a software patch with a desired feature set comprising one or more features, the system comprising a processor configured to:
determine existing features of an existing set of existing software including any features associated with previous software patches to the existing software; and
create the software patch as an accretive patch that includes only features of the desired feature set absent from the existing features, such that when the software patch is applied, the existing software together with the software patch provides the desired feature set.

5. The system of claim 4, wherein the processor is further configured to store the software patch in one-time programmable memory or random access memory of a target device for the software patch.

6. The system of claim 4, wherein the processor is further configured to creating the software patch such that executable code of the software patch updates a jump table stored in random access memory of the target device to reference the desired feature set.

7. A method for using a software patch with a desired feature set comprising one or more features, the method comprising:
applying a software patch comprising an accretive patch that includes only features of a desired feature set absent from existing features of existing software including any features associated with previous software patches to the existing software, such that when the software patch is applied, the existing software together with the software patch provides the desired feature set.

8. The method of claim 7, further comprising storing the software patch in one-time programmable memory or random access memory of a target device for the software patch.

9. The method of claim 7, further comprising updating, with executable code of the software patch, a jump table stored in random access memory of the target device to reference the desired feature set.
